(19) United States
(12) Patent Application Publication
(10) Pub. No.: US 2016/0180201 A1
(43) Pub. Date: Jun. 23, 2016

(54) IMAGE PROCESSING

(71) Applicant: International Business Machines Corporation, Armonk, NY (US)

(72) Inventors: Denis Aubert, St. Paul de Vence (FR); Franck Boudinet, Villeneuve Loubet (FR); Joaquin Picon, St Laurent du Var (FR); Bernard Y. Pucci, Cagnes sur mer (FR)

(21) Appl. No.: 14/948,621

(22) Filed: Nov. 23, 2015

(30) Foreign Application Priority Data
Dec. 22, 2014 (GB) 1422930.6

(51) Int. Cl. G06K 9/62; G06T 7/60; G06K 9/52; G06K 9/46

(52) U.S. Cl. CPC G06K 9/6267; G06K 9/46; G06T 7/60; G06K 9/52; G06K 2009/4666

(57) ABSTRACT

A method of processing an image including: receiving an image of pixel data; identifying an object within the image; determining a presence of a predetermined grid in at least part of the identified object; defining a shadow portion of the identified object; removing the defined shadow portion from the identified object; and storing the amended object.

### TECHNICAL FIELD

This invention relates to a method of, and system for, processing an image.

### BACKGROUND

The automatic identification of an object in an image is a well-known technology. The pixel data that makes up the image is processed by one or more algorithms in order to identify one or more objects within the image. Many different techniques can be used either singly or in combination to determine the presence of an object in an image. Many such techniques use some kind of edge detection in the image, which will examine adjacent pixels to determine where there is a clear change in colour and/or brightness in the image and identify where these changes are likely to be linked together in order to determine an edge running in an image.

All manner of post-processing techniques can also be used to filter out false positives and return data that only specifically identifies objects (with a very high likelihood) within an image. However, one well-known problem within the field of object identification within an image is the presence of shadows within the image. Since lighting within a scene captured in an image will have many different possible effects, objects within an image will frequently have one or more shadows associated with them, which will make it more difficult to correctly identify an object and correctly identify the extent of the object.

### SUMMARY

According to an aspect of the present disclosure, there is provided a method of processing an image, the method including: receiving an image of pixel data; identifying an object within the image; determining the presence of a predetermined grid in at least part of the identified object; defining a shadow portion of the identified object; removing the defined shadow portion from the identified object, and storing the amended object.

According to another aspect of the present disclosure, there is provided a system for processing an image, the system including a processor arranged to: receive an image of pixel data; identify an object within the image; determine the presence of a predetermined grid in at least part of the identified object; define a shadow portion of the identified object; remove the defined shadow portion from the identified object; and store the amended object.

According to a third aspect of the present disclosure, there is provided a computer program product stored on a non-transitory computer readable medium for processing an image when executed by a computer system, the product comprising instructions for: receiving an image of pixel data; identifying an object within the image; determining the presence of a predetermined grid in at least part of the identified object; defining a shadow portion of the identified object; removing the defined shadow portion from the identified object; and storing the amended object.

As described herein, it is possible to provide a technique which will correctly identify an object within an image, while compensating for any shadow that the object will cast within the image. In general, an object within the image will fully obscure the grid present in the image, but the shadow will only partially obscure the image. This will allow the identification of the object itself versus the shadow that it casts, with the result that the shadow can be identified and removed from the object before it is finally defined and captured. For example, a vehicle passing over a grid painted on a road surface will clearly obscure the grid, but the shadow of the vehicle will only partially obscure the grid and this distinction can be identified within the image. The “shadow+grid” part of the image can be identified and this can be removed from the object, thereby increasing the accuracy of the object identification. Multiple objects within the image can be identified using the same technique of image processing.

The method may further include: receiving a second image of pixel data; identifying the object in a different location within the image; removing the defined shadow portion from the identified object; and storing the amended object. Once an object has been identified and had its shadow removed, the same object can then be identified in a second image. For example, in the vehicle example mentioned above, the same camera that captures the vehicle on the road while it is over the grid, can identify the vehicle once it has moved onwards and is no longer over the grid, since the removed shadow can be used to process the second image and remove the shadow identified in the first image from the object captured in the second image. This allows objects to be tracked accurately within an image once they have been captured, even if the objects are casting large and complex shadows.

Advantageously, the method further includes, following removal of the defined shadow portion from the identified object, determining that the identified object includes two distinct objects and storing the two distinct objects separately. It is possible that two separate objects within an image will appear to be a single object, if the shadow of one of the objects touches the other object. The processing method can be used to separate the two objects, since the shadow portion will be identified from the visible grid present in the shadow area, and once this has been removed, it will leave two distinct objects that can be saved separately. This is a significant advantage over existing techniques that struggle to separate objects that are combined by an overlapping shadow from one of the objects.

The method may further include: receiving a reference image of pixel data; identifying the presence of the predetermined grid in the reference image; and storing the predetermined grid in a reference file. The processing can be assisted by the provision of a reference image that defines the predetermined grid that will be present in the future images to be processed. This reference image can be used in combination with the received image to work out where in the image shadows are present. Every object with a shadow has the shadow removed once it has been detected through the presence of the grid within the shadow portions of the image.

The predetermined grid may comprise a regular pattern of straight lines travelling in two different directions. The grid can include two sets of lines at right angles to each other, each set of lines being parallel. This provides a grid that can be easily identified in the image and provides the basis for the processing that will identify the shadow cast by objects from the partially obscured grid being present in the objects' shadow.

### BRIEF DESCRIPTION OF THE DRAWINGS

Various embodiments will now be described, by way of example only, with reference to the following drawings.

FIG. 1 is a schematic diagram of a road with a vehicle thereon.

FIG. 2 is a schematic diagram of components in an image processing system.

FIG. 3 is a schematic diagram of an image.

FIG. 4 is a flowchart of a method of processing an image.

FIG. 5 is a schematic diagram of an image before and after processing.

FIG. 6 is a further flowchart of a method of processing an image.

### DETAILED DESCRIPTION

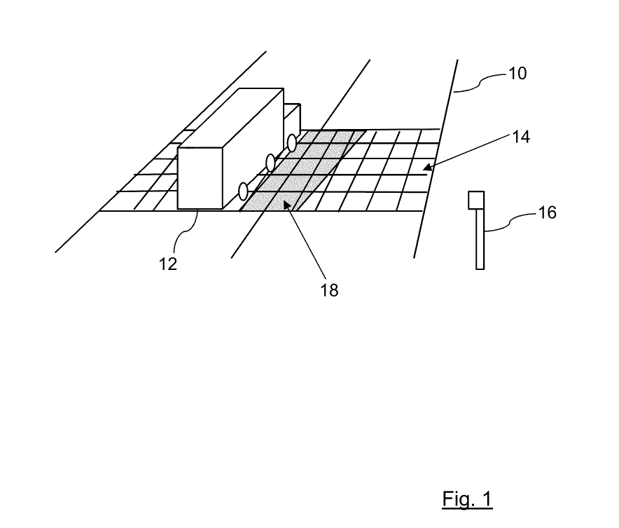

FIG. 1 shows a road 10, with a vehicle 12 thereon. The road 10 has a grid 14 painted on it in one particular location. The grid 14 may include a cross-hatching of lines in two perpendicular directions, with the lines of the grid 14 being parallel in each direction. A fixed camera 16 is continually acquiring images of the road 10. The camera 16 could be part of a traffic monitoring system, for example, which is common in many urban environments, where traffic monitoring is continually performed for public monitoring and traffic flow reasons. The camera 16 may be a video camera that is capturing x number of frames per second, for example twenty frames per second.

In many situations it is advantageous to identify the presence of individual vehicles 12 within the images captured by the camera 16. This could be for establishing flow rates at different times of day in terms of the number of individual vehicles passing a particular point per minute, for example. This process needs to be automated since in any urban area above a certain size, the number of cameras 16 in use would be very large. The output of the camera 16 is transmitted, wirelessly or by a fixed line connection to a central processing facility that can process the images received from the camera 16 automatically using one or algorithms.

In the case of the vehicle 12, this vehicle 12 also casts a shadow 18 onto the road 10, which can cause problems with image processing, depending upon the algorithm(s) used and the purpose for which data is being extracted from the images. For example, in congested situations, it is quite common for vehicle shadows to be cast onto other vehicles. This makes the detection of individual vehicles far more complex and can lead to errors in vehicle counting, for example. Shadows can also change the size and shape of detected objects, which makes object identification difficult, if automatic techniques are used to identify objects in the field of view.

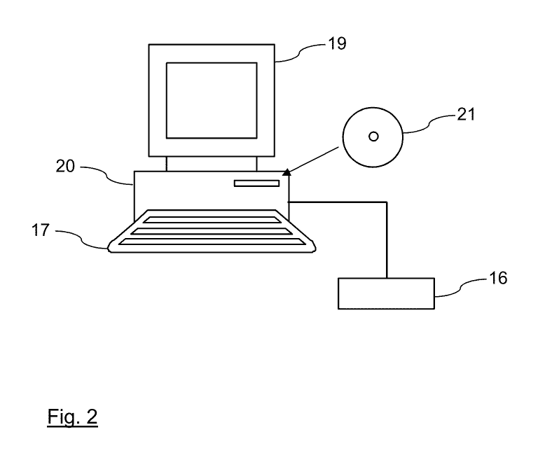

FIG. 2 shows schematically the camera 16 as connected to a processor 20, which can provide visible output through a display device 19 and receive input via a keyboard 17. The processor 20 is controlled by a computer program product on a computer readable medium 21, which may include a CD-ROM 21. Images captured by the camera 16 are passed to the processor 20, which can process the images in real-time. The image processing is controlled by the instructions of the computer program product, which operates one or more algorithms to perform the image processing. Multiple cameras 16 can be connected to the single processor 20, which can simultaneously process many different images from many different cameras 16.

The image processing may be used to identify objects within the received images. Integral with this process is the removal of object shadow 18 from the objects, so that they can be identified correctly within the field of view of the camera 16. The principle behind this process is that the grid 14 on the road 10 will be obscured by the actual vehicle 12, but will only be partially obscured by the shadow 18. When an object is found in the image of the road 10, then further processing of the received image can be performed to detect which part of the object is actually object shadow.

Once an object is determined to contain object shadow, then the shadow can be removed from the object in post processing, and the amended object saved without the shadow. In general, edge detection will often result in object selection that includes the object's shadow, and the detection of the presence of the shadow (from the partially obscured grid 14) will allow this shadow to be removed, for a more accurate result. Amended objects can then be used for whatever purpose the data is being taken from the images provided by the camera 16, such as object counting or object identification. Any object detected which is currently over the grid 14 will have its shadow removed.

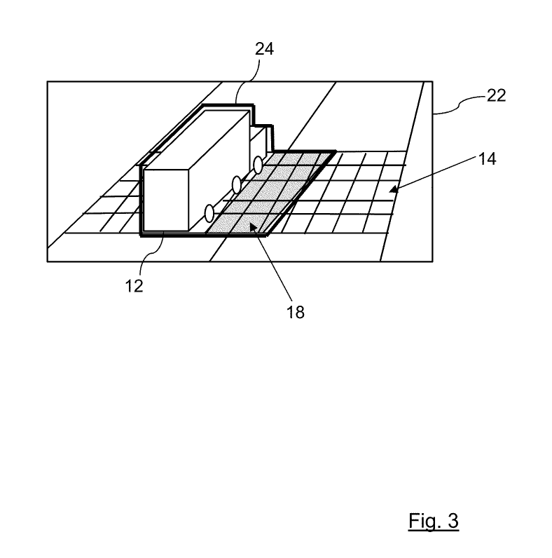

FIG. 3 shows an image 22 in which an object 24 has been identified (shown schematically to illustrate the concept). The object 24 in the image 22 corresponds to the vehicle 12 and shadow 18, as shown in FIG. 1. The presence of the partially obscured grid 14 in the shadow portion 18 of the object 24 allows the removal of the defined shadow portion 18 from the identified object 24, which can now be saved as an amended object. Analysis of the colour values of the pixel data that makes up the image 22 means that the shadow portion 18 of the object 24 can be identified within the object 24 and subsequently removed by the post processing.

The amended object can be used to identify the vehicle 12 in other images 22. The same camera 16 will of course capture other images 22 that will contain the vehicle 12 in other positions, as the vehicle 12 travels along the road 10. In some of the additional images 22 the vehicle 12 will no longer be covering the grid 14, but will have a shadow cast from the light source(s). The original shadow portion 18 that was used to remove the shadow from the object 24 in the first image 22 can therefore be re-used to remove the same shadow from the object 24 captured in a subsequent image 22. As the vehicle 12 moves on, its size reduction can be calculated and the same factor can be applied to the original shadow 18 to deduct the new shadow size.

In general, one purpose of video surveillance systems is to detect, and recognize objects. However the sun or other light sources introduce difficulties by adding a shadow 18 to the object 24. This problem is solved for the video surveillance system by filtering out the object shadow 18. It is also possible that two different objects 24 identified by the video surveillance system may become a single object if the shadow 18 of one object touches the second object. In that case a video surveillance system may lose track of the two objects. Being able to eliminate object's shadow highly improves the capacity of the video surveillance system to recognize, identify and keep track of objects.

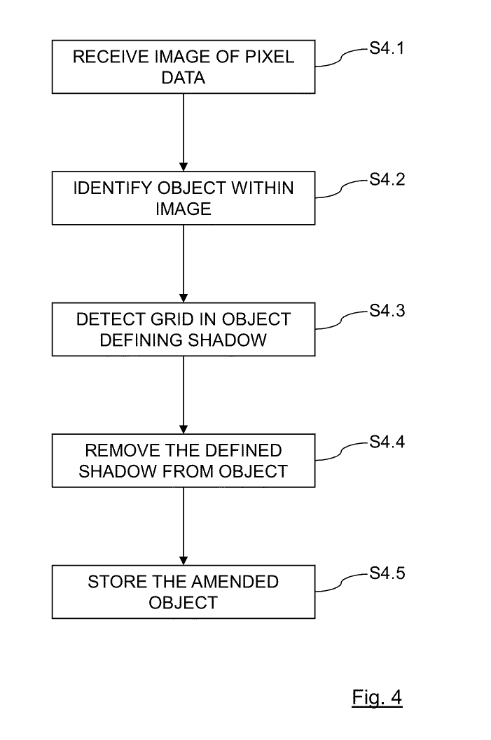

FIG. 4 is a flowchart of a method of processing the image 22. The method includes the steps of, firstly step S4.1, which includes receiving an image 22 of pixel data, secondly step S4.2, which includes identifying an object 24 within the image 22, thirdly step S4.3, which includes determining a presence of a predetermined grid 14 in at least part of the identified object 24, defining a shadow portion 18 of the identified object 24, fourthly step S4.4, which includes removing the defined shadow portion 18 from the identified object 24, and finally step S4.5, which includes storing the amended object. The output of the process is the amended object without the original shadow 18.

Following removal of the defined shadow portion 18 from the identified object 24 in step S4.4, it may be determined that the identified object 24 comprises two distinct objects and therefore the two distinct objects can be stored separately. In this way, the method is able to separate two different objects within the image 22 that are joined together by the shadow of one object falling on another object. As mentioned above, in a traffic management system for example, the presence of multiple vehicles in a brightly lit environment is likely to lead to many vehicles having their shadow fall on other vehicles. The method can deal efficiently with this problem.

As mentioned above, based on the camera position, date and time it is possible to calculate what the shadow 18 should be when the object 24 goes beyond the grid 14 of stripes and filter its shadow from the image 22 avoiding a collision between real objects and their shadow. In summary, the solution uses a stripe pattern to be drawn on the surface, and a modification of the real time software analysis such that the geolocatization of the camera, time, and date are input parameters. The algorithm calculates the shadow area 18 of the object 24 when it is above the pattern 14 for filtering and recalculating as the object 24 moves beyond this area until it disappears from the image 22.

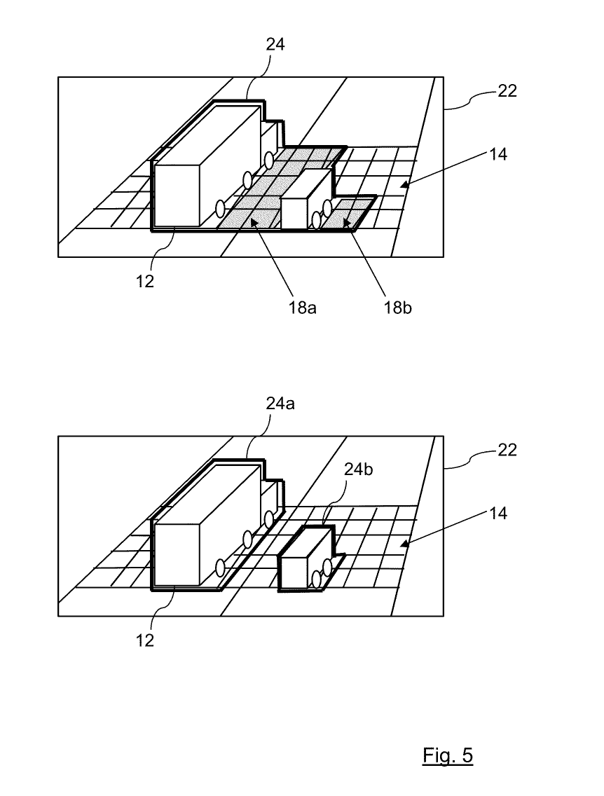

FIG. 5 shows schematically how an image 22 might look, in the case where a single object 24 actually contains two separate objects 24a and 24b that are joined by a shadow 18a. The object 24b also has its own shadow 18b. In the top image 22, it can be seen how the initial edge detection process has detected an apparent single object 24 in the image 22, which includes both objects 24a and 24b and both shadows 18a and 18b. However, the presence of the grid 14 in the image 22 (which the process either detects itself within the image 22 or uses a reference image to obtain) means that the process described above with reference to FIG. 4 can detect the shadows 18a and 18b.

Once the shadows 18a and 18b have been removed, then the resulting image 22 is shown in the lower part of FIG. 5, where the two objects 24a and 24b are now clearly distinct and separate from one another. The process of shadow identification has been able to identify the shadow portions 18a and 18b in the image 22 and remove them from the image 22, on the basis that these shadow portions 18a and 18b contain elements from the grid 14 which are therefore present within the shadow portions 18a and 18b as partially obscured elements. Since the actual objects 24a and 24b completely obscure the elements of the grid, these can be distinguished.

The separation process described in respect of this Figure can also work with larger collections of objects 24 that are all linked together by a chain of shadows 18 in an image 22. It can be imagined, for example, that in a four-lane highway, four vehicles that are travelling in different lanes could all be joined together in an image 22 by the presence of the shadows 18 of three of the vehicles. Once the four vehicles are over the grid 14, then they can all be separated by the process described above, since the partially obscured grid 14 will identify the shadows 18, which can then be removed from the image 22, leaving the four separate objects 24.

The solution provided by the methodology is based on the fact that white stripes painted on a road surface can be seen even when they are under the shadow of an object. The shadow corresponding to an object can be identified thanks to the stripes painted on the road while the vehicle hides the stripes. Therefore it is possible to filter the shadow and remove the part of the detected blob which does not belong to the real object. One advantage of the solution is to better identify objects by eliminating their shadow. Since the image analysis is done in real time, the solution minimises the computation power required to perform the shadow filtering.

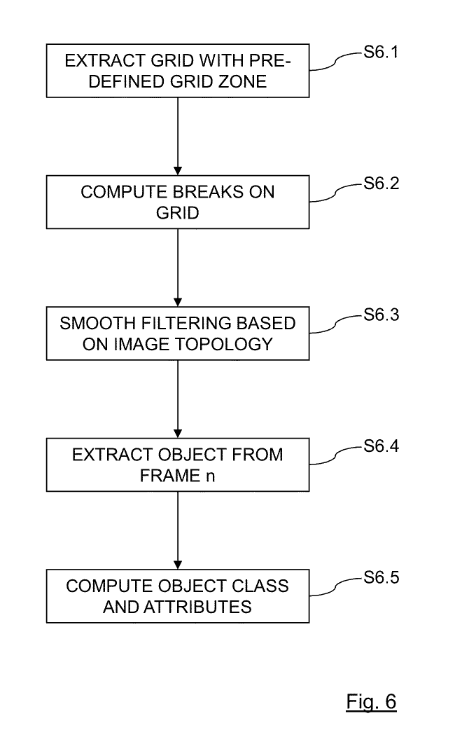

FIG. 6 illustrates in more detail one embodiment of the frame processing that takes place on a frame n that corresponds to an image of pixel data. Step S6.1 includes extracting the grid 14 using the predefined grid zone, which extracts the visible grid zone from the frame including where the grid 14 is present in shadow areas. Step S6.2 includes computing breaks in the extracted grid, which effectively detects the object areas without their shadows (since an object on the grid 14 will be visible as breaks in the grid 14). Step S6.3 includes performing smooth filtering based on image topology, using the last five frames to compute the object size and centroid. Based on the centroid position predefined scaling can be applied.

Step S6.4 includes extracting the object from the frame n and step S6.5 includes computing the object classification and computing the object attributes. In this way a shadow-less object is extracted from the frame n and can now be post processed according to the application for which the video surveillance is operating. When setting the grid zone configuration, perspective calibration can be used, for example based on the detection of people in the image as different points, which can be used to determine the depth in the image. The grid detection in the image can be performed using edge filtering, for example by using a standard Laplace filter.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of processing an image, the method comprising:
receiving an image of pixel data;
identifying an object within the image;
determining a presence of a predetermined grid in at least part of the identified object, defining a shadow portion of the identified object;
removing the defined shadow portion from the identified object; and
storing the amended object.

2. A method according to claim 1, further comprising:
receiving a second image of pixel data;
identifying the object in a different location within the image;
removing the defined shadow portion from the identified object; and
storing the amended object.

3. A method according to claim 1, further comprising, following removal of the defined shadow portion from the identified object:
determining that the identified object comprises two distinct objects; and storing
the two distinct objects separately.

4. A method according to claim 1, further comprising:
receiving a reference image of pixel data;
identifying the presence of the predetermined grid in the reference image; and
storing the predetermined grid in a reference file.

5. A method according to claim 1, wherein the predetermined grid comprises a regular pattern of straight lines travelling in two different directions.

6. A system for processing an image, the system comprising a processor arranged to:
receive an image of pixel data;
identify an object within the image;
determine a presence of a predetermined grid in at least part of the identified object, defining a shadow portion of the identified object;
remove the defined shadow portion from the identified object; and
store the amended object.

7. A system according to claim 6, wherein the processor is further arranged to:
receive a second image of pixel data;
identify the object in a different location within the image;
remove the defined shadow portion from the identified object; and
store the amended object.

8. A system according to claim 6, wherein the processor is further arranged to, following removal of the defined shadow portion from the identified object:
determine that the identified object comprises two distinct objects; and
store the two distinct objects separately.

9. A system according to claim 6, wherein the processor is further arranged to:
receive a reference image of pixel data;
identify the presence of the predetermined grid in the reference image; and store
the predetermined grid in a reference file.

10. A system according to claim 6, wherein the predetermined grid comprises a regular pattern of straight lines travelling in two different directions.

11. A computer program product stored on a computer readable medium for processing an image when executed by a computer device, the product comprising instructions for:
receiving an image of pixel data;
identifying an object within the image;
determining a presence of a predetermined grid in at least part of the identified object, defining a shadow portion of the identified object;
removing the defined shadow portion from the identified object; and
storing the amended object.

12. A computer program product according to claim 11, further comprising instructions for:
receiving a second image of pixel data;
identifying the object in a different location within the image;
removing the defined shadow portion from the identified object; and
storing the amended object.

13. A computer program product according to claim 11, further comprising instructions for, following removal of the defined shadow portion from the identified object:
determining that the identified object comprises two distinct objects; and storing
the two distinct objects separately.

14. A computer program product according to claim 11, further comprising instructions for:
receiving a reference image of pixel data;
identifying the presence of the predetermined grid in the reference image; and
storing the predetermined grid in a reference file.

15. A computer program product according to claim 11, wherein the predetermined grid comprises a regular pattern of straight lines travelling in two different directions.
